(19) United States
(12) Patent Application Publication
(10) Pub. No.: US 2011/0021163 A1
(43) Pub. Date: Jan. 27, 2011

(54) ANTENNA OPTIMIZATION

(76) Inventors: Ulf Lindgren, Vastra Frolunda (SE); Mikael Coldrey, Landvetter (SE); Sven Oscar Petersson, Savedalen (SE); Fredrik Harrysson, Goteborg (SE)

Correspondence Address: ERICSSON INC., 6300 LEGACY DRIVE, M/S EVR 1-C-11, PLANO, TX, 75024, US

(21) Appl. No.: 12/933,716

(22) PCT Filed: Mar. 28, 2008
(86) PCT No.: PCT/EP2008/053754

§ 371 Date: Sep. 21, 2010

(51) Int. Cl. H04B 1/38

(52) U.S. Cl. 455/90.2

(57) ABSTRACT

The present invention relates to a solution for efficient handling of radio resources in communication devices in a wireless communication network. In the solution a subset of available antennas to be used is chosen using a method for determining a singular valued metric from a sub matrix related to a full channel matrix. Sub-channel matrices are chosen by deducing the metric and comparing to other sub-matrices. Preferably the best sub-channel matrix is used to determine a suitable full channel matrix to use in communication and this full channel matrix is communicated to each involved communication device.

### TECHNICAL FIELD

The present invention relates to a solution for optimizing the usage of antennas in a MIMO system and in particular to a solution for selecting which antennas to use in the MIMO system given specific configurations in a communication network.

### BACKGROUND OF THE INVENTION

In MIMO (multiple input multiple output) systems a plurality of antennas are used for transmitting and receiving radio signals in order to improve the performance of radio communication systems by providing different types of diversity. A problem often present in MIMO solutions is a configuration where there are more antennas than power amplifiers available; this may be the case for a laptop for instance with built in wireless communication.

MIMO coding may be divided into three main categories: pre-coding, multiplexing, and diversity coding.

Pre-coding means that the same signal is emitted from each of the transmit antennas with appropriate phase weighting in order to provide beam forming to maximize the reception at the receiver input: the streams are superimposed at the receiver side. The benefits of beam forming are to increase the signal gain from constructive combining and to reduce multi-path fading effects. In the absence of scattering, beam forming results in a well defined directional pattern.

Spatial multiplexing requires MIMO antenna configuration. In spatial multiplexing, a high rate signal is split into multiple lower rate streams and each stream is transmitted from a different transmit antenna in the same frequency channel. If these signals arrive at the receiver antenna array with sufficiently different spatial signatures, the receiver can separate these streams, creating parallel channels. The maximum number of streams is limited to the lesser the number of antennas at the transmitter or receiver.

In diversity coding methods a single stream is transmitted, but the signal is coded using techniques such as space-time coding. The signal is emitted from each of the transmit antennas using certain principles of full or near orthogonal coding. Diversity exploits the independent fading in the multiple antenna links to enhance signal diversity.

Some of these techniques may be combined for certain situations and/or configurations.

A MIMO system for which one would like to achieve the channel capacity, it is well known that the antenna array weights shall be chosen as the singular vectors to the channel matrix (here it is assumed that the channel is flat, e.g. an individual sub carrier in an OFDM symbol). To this end, one chooses the singular vectors which correspond to the largest singular values of the system. The remaining, if any, singular values are not used. Two topics or methods will be addressed in the present invention. The first method is a general antenna element selection schema. The second topic describes a method for reduction of the number elements used in a ULA (Uniform Linear Array).

In a system for MIMO transmission, it is likely that constraints are present, for example shared power amplifiers and distributed antennas. This means that the system configuration puts restriction on how many streams that can be active; which antennas to use given a specific antenna distribution, etc. In the special case of an ULA antenna the channel singular vectors can be regarded as beam former weights. However, for the general case where antennas can occur in any spatial distribution the beam former concept looses meaning, since no coherent addition may take place. In such case the singular vectors can be regarded as a spatial equalizer.

The success of a MIMO deployment depends on the characteristics of the channel. In the ULA case the antenna diagram formed by the singular vector as weights, points in directions which correspond to favorable clusters in the channel. The ULA comprise N antenna elements, which are used to transmit or receive M data streams. Theoretically, it is possible to have at most M=N data streams. The number of streams is, as previously stated, determined by the channel properties. This implies that in cases where the channel cannot support N streams the number of antenna elements are in excess of the number of streams, e.g. N>M. Hence, the elements in excess can be used for other purposes such as diversity or common information. By exploiting diversity is here meant that destructive combining does not occur, e.g. by resending a symbol (ARQ). In addition, a device, such as a PC, may have an excess of antennas when compared to the number of radio chains or amplifiers. Therefore, it may become necessary to choose the best combination of antenna elements given the radio channel.

A parallel to reducing the number of elements in a beam former or a general setup with distributed antennas is that of model order selection. Model order selection deals with the problem of choosing the minimum number of parameters required to appropriately model a set of data, given a model set. Basically, this is extraction of information in observations such that any residual does not carry additional information. Typically, for a linear model this means that the residual is white noise. As the model order increase the residual carry less information, implying that the model order should be chosen as high as possible. However, then the data set must be increased too. Obviously, for practical purposes the data set is finite as is the number of parameters. A parameter estimator will, in a stochastic framework, result in a parameter variance which depends on the number of parameters. That is, an over parameterization increases the parameter variance. The trade off between parameters and data points is the foundation of model order selection.

Today it is common knowledge that a MIMO transmission requires that the channel contains sufficiently many modes in order to pass M signals. Moreover, the power needed for the transmission is limited and must be appropriately used. A schema for distributing the power on the modes of the channel is the so called water filling algorithm. Upon realizing the achievable channel capacity (using a so called water filling method) the singular vectors, corresponding to the singular values incorporated in the water filling, are used at the transmitter and receiver. Since the singular vectors are used all antenna ports are weighted using the selected vectors. This is also the case when the system is a ULA (Uniform Linear Array), the optimal weights are applied to the entire ULA.

Today, normally all the antenna elements are used in a transmission. This means that there is no “array” order selection. The weights for, e.g. an ULA, may be computed via the SVD (Single Value Decomposition) and reducing the number of weights requires additional SVDs. SVD is a form of factorization of a rectangular real or complex matrix and is known to the skilled person.

In WO2007040564 is disclosed a solution that is arranged to select only a sub selection of available antennas. This solution uses a plurality of sounding packages transmitted between two entities in a communication link in order to estimate a channel matrix. A sounding package is transmitted for each sub-set of antennas in the combined system. The transmittal and estimation is done during a training period and the estimated channel matrix is communicated to other entities in the communication link and stored in each entity for later use during transmittal of communication data. However, this solution is complex and requires communication overhead and extensive calculations.

US20070140363 illustrates an example where a channel matrix is determined and transmission rates for each available antenna are determined. The transmission rates are determined by computing the signal to noise ratio for each antenna combination and using a water filling method for selecting each transmission rate.

### SUMMARY OF THE INVENTION

It is an object of the present invention to provide a device, method, and system that may increase efficiency in antenna systems while at the same time provide a cost effective solution.

Heuristically, an antenna system can be viewed as a parameterized model, where the parameters are weights for the ports. In this perspective the parameters used to model the desired objective is a variable quantity. By pruning the antenna system, elements may be freed. Hence, antenna elements are available for alternative purposes. Alternatively the resources in the system may be limited elsewhere, for example a laptop computer may be equipped with say six antenna elements but only three radios. Furthermore, the six antennas are connected via a switch to the three radios. This implies that out of those six antennas there are combinations of three antennas which are better than other. In order to find the optimal setting one must determine the best combination in some sense.

The pruning or selection can be carried out in several ways; in the present disclosure three viable methods are discussed; however, only the last two are of interest in for the present invention. Briefly, the methods are: 1) root pruning based on their location; 2) viewing the array as a spatial predictor; 3) exhaustive search using SVD.

A solution is provided in a first aspect of the present invention, a communication node for controlling wireless communication in a communication network, the node comprising a transceiver portion, a processing unit, a memory unit, and a network communication interface, the transceiver portion is arranged to control a plurality of antennas, wherein the processing unit is arranged to determine the number and identity of antennas to use in a communication session with another communication node and wherein the processing unit is arranged to determine at least one metric for at least one sub-set of available channel matrices of a full channel matrix for the transmission and choosing an antenna configuration for which the metric is within a pre-determined range.

A metric of the sub-set of available channel matrices may be chosen from at least one of arithmetic mean, geometric mean, a predictor polynomial filter algorithm, or channel capacity.

The communication node may further be arranged to determine the channel matrix using the sub-set and to transmit the determined channel matrix to at least one other node in the communication network. The communication node may further be arranged to select which node that is to control the number of antennas to use in transmission of data.

The processing unit may be arranged to periodically change antennas used for transmitting control messages and/or arranged to determine signal quality for the antenna configuration available in order to determine the channel matrix using pilot signals in control messages.

The communication interface may comprise at least one of wireless local area network, a wireless personal local area network, and a cellular network interface.

Another aspect of the present invention, a method for optimizing a communication link using a plurality of antennas is provided, comprising the steps of:
Computing a singular valued decomposition of a full channel matrix of an antenna system between two nodes in a wireless communication network;
Initializing a quality metric;
Choosing elements from the channel matrix and obtaining a sub-channel matrix;
Computing and storing the quality metric for the obtained sub-channel matrix;
Comparing the computed quality metric with previously computed quality metrics for other sub-channel matrices;
Choosing a suitably valued metric from the comparison;
Selecting the corresponding sub-channel matrix and computing the SVD using this sub-channel matrix;
Using obtained sub-channel matrix configuration for transmitting and receiving communication data.

The step of computing the metric may comprise at least one of using geometric and/or arithmetic mean, a predictor polynomial, or a channel capacity.

The method may further comprise a step of determining the channel matrix using the obtained sub-channel matrix configuration and communicating the channel matrix to involved radio devices. The method may further comprise a step of periodically change antennas used for transmitting control messages.

Yet another aspect of the present invention is provided, a system for wireless communication in a communication network, comprising
a communication node according to the first aspect;
at least two antenna elements;
wherein the communication node controls transceiver signals to the at least two antenna elements using separate power amplifiers.

The method according to the present invention may also be implemented as a computer program operating in the processing unit in the device of the first aspect.

These and other aspects of the invention will be apparent from and elucidated with reference to the embodiments described hereinafter.

With the solution according to the present invention, it is provided an advantage of better usage of available radio resources using a cost effective method of determining suitable antennas and other resources to use in communication transmissions and which may be implemented in a cost efficient manner. For instance providing a cost efficient method for determining a suitable configuration of power amplifiers and antennas for use in a communication situation.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a network system according to the present invention;

FIG. 2 illustrates schematically a device with an antenna configuration according to the present invention;

FIG. 3 illustrates schematically in a block diagram a method according to the present invention;

FIG. 4 illustrates schematically a uniform linear antenna array according to the present invention; and

FIGS. 5 to 9 show results from various simulations using the solution according to the present invention.

### DETAILED DESCRIPTION OF PREFERRED EMBODIMENTS

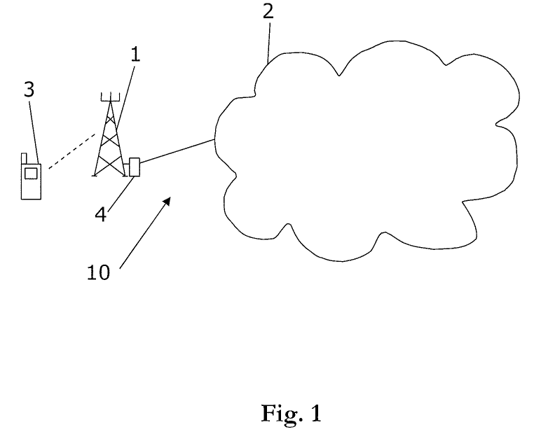

In FIG. 1 reference numeral 1 generally indicates a base station or similar wireless access gateway (e.g. access point) to an infrastructure communication network 2. The base station 1 is arranged to communicate wirelessly with user equipment 3. The base station also comprises a radio controller 4 for controlling the wireless communication and for controlling communication with the infrastructure network 2. The base station 1 may comprise a plurality of antennas and/or a plurality of base stations may be controlled by the radio controller 4. It should be noted that the exact configuration of the base station is not critical to the invention as long as there are a plurality of antennas and a device controlling the radio resources which will be apparent later in this document.

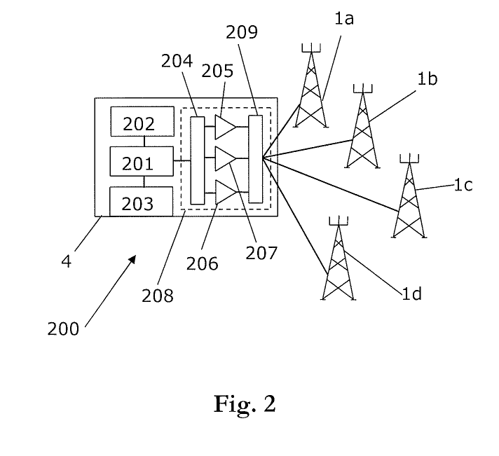

In FIG. 2 is shown a system with a communication device 4 (for instance a radio controller in a base station, radio network controller, or terminal device (UE)) implementing the solution according to the present invention is shown. The device may comprise at least one processing unit 201, at least one memory unit 202, and at least one communication interface 203. Furthermore, the device comprises a transceiver portion 208 for receiving and transmitting radio signals. The transceiver portion may comprise AD/DA unit(s) 204, at least one power amplifier 205, 206, 207, and optionally a switch/multiplexer 209. The processing unit is arranged to run code for communication control and data traffic. It is further arranged to determine which antennas to use in a MIMO communication configuration. The processing unit 201 may comprise a microprocessor, an ASIC (Application Specific Integrated Circuit), or an FPGA (Field Programmable Gate Array). The memory unit 202 may comprise any suitable type of memory (volatile and/or non-volatile) such as e.g. RAM, ROM, EEPROM, Flash, and hard disk. The communication interface 203 connects the device 4 to the infrastructure network 2. It should be understood by the skilled person that other communication equipment may be present as well depending on the type of wireless communication protocol/standard used. In FIG. 2 the transceiver 208 is shown as a transmitter for illustrative purposes, but it should be appreciated that also a receiver may be implemented with the solution according to the present invention and also a combination of transmitter and receiver—transceiver may be implemented according to the present invention.

The switch and/or multiplexer 209 is provided to distribute transceiver signals to/from the antennas 1a-1d in a manner determined by the solution according to the present invention. The switch/multiplexer may be used in a configuration with only one power amplifier (PA) or with a number of PAs that are less then the number of available antennas. Furthermore, the switch/multiplexer may be used for selecting antennas for different communication channels (different user communications or different sessions).

It should be noted that the transceiver portion 208 may be configured in different ways depending on radio technology and/or communication protocol used as understood by the skilled person.

The present invention is applicable to all types of wireless communication setups that use a plurality of antennas for transmitting and/or receiving communication signals. In many configurations, the number of antennas available for a transceiver is larger than the available amplifiers. Therefore, the processing unit handling the radio resources may be arranged to determine the number of antennas to use and which antennas should be utilized in the communication. Even in cases where the power amplifiers are of the same number as the available antennas it is of interest in some cases to utilize only some of the antennas, this has the benefit of reducing power consumption and/or using some antennas for other communication transmissions.

In a MIMO-system (Multiple input Multiple output) antenna elements may be weighted using the singular vectors of the channel matrix. Assuming that the channel is known these weights will ensure that the channel capacity may be more optimally utilized (however, additional requirements on power may also be needed to be fulfilled in order to fully exploit the capability of the channel capacity, these requirements may be linked to for instance power restraints set on a channel, cell, or other power restraints, and/or to direction of transmission considering a directive antenna configuration). The number of antenna elements deployed equals the dimension of the singular vector. However, the singular vector can also be regarded as a spatial filter. Here, the spatial filter would represent the weights in a beam former. In the context of beam forming one can regard it as means for interference rejection, i.e. not passing energy in given directions. For a root pruning model, this implies that the roots to the polynomial, which defines the spatial filter, provides a source of information. In a linear parametric model one tries to capture the essence of the data. For example a sinusoidal signal is uniquely described by two parameters in an AR model (autoregressive). Model parameters, such as the AR model, are typically found by solving a least squares problem. The solution involves an inverse of a covariance matrix and this matrix should be a two by two matrix. Assuming that the model order is variable, one may of course estimate a four by four covariance matrix. However, the rank of this matrix is two for the noiseless case. In a scenario where additive white noise is present the covariance matrix will be full rank. Consequently, the model is over parameterized and the extra parameters only contribute to uncertainties in the output.

A starting point for the sequel is a general MIMO system. The MIMO system is characterized by the communication channel H. This channel describes all paths which may be constructed between the transmitter and receiver antenna elements. Obviously, the channel is a matrix with dimension Nᵣ×Nₜ where Nᵣ and Nₜ are the number of antenna elements at the receiver and transmitter side, respectively. The channel matrix may be obtained from offline measurements or estimated during transmission of pilot blocks. Here, the channel is modeled as a stochastic matrix for which a receiver and transmitter correlation matrix is used. Denote by Rᵣ and Rₜ the receiver and transmitter correlation matrix, respectively. The transmitter and receiver correlation matrix may be constructed from a correlation vector, e.g. a Toeplitz matrix (or diagonal-constant matrix). The joint correlation may be computed as

R=Rₜ [symbol] Rᵣ (1)

where [symbol] is the Kronecker product. The square root of the joint correlation, R, is used to construct the channel matrix by multiplying by a random vector, w, and rearranging the resulting vector to a matrix. The channel is:

$$H - {vec}^{- 1} ( {\tilde{R}}^{T} w ) = [ \begin{matrix}{h}_{11} & {h}_{12} & … & {h}_{1 {N}_{t}} \\ ⋮ & ⋱ & & ⋮ \\ ⋮ & & ⋱ & ⋮ \\ {h}_{{N}_{r} 1} & {h}_{{N}_{r} 2} & … & {h}_{{N}_{r} {N}_{t}}\end{matrix} ] \qquad ( 2 )$$

where vec⁻¹ is the inverse of the vec operator. Evidently, by eliminating rows in H, transmit antenna elements are removed. Receive antenna elements are removed by removing appropriate columns.

Suppose that the channel is estimated using Nᵣ receive and Nₜ transmit antennas and that the corresponding SVD has been computed. Then by evaluating this total SVD it is possible to draw a conclusion on how many simultaneous data streams the channel can support, given the power constraints. The number of streams is denoted by N_{d}, then it is possible to construct an antenna sub-system which has dimension N_{d}×N_{d}. Reducing the system to a theoretical minimum is not necessary or even possible. For instance assuming that the system can be reduced to a bare minimum requires control over the antenna system at both end of the radio link. Moreover, since elements are removed contributions of power in certain directions may cause the reduced system to require more power than is available. Nevertheless, there exist several antenna sub-systems. By allowing reduction of elements on both the receive and transmit side the number of possible antenna subsystems is

$${N}_{S} = ( \begin{matrix}{N}_{r} \\ {N}_{d}\end{matrix} ) ( \begin{matrix}{N}_{t} \\ {N}_{d}\end{matrix} ) \qquad ( 3 )$$

Equation (3) can become quite large even for moderate values of the parameters Nᵣ, Nₜ and N_{d}. To reduce the number of combinations one can stipulate that only one side has the capability to reduce the antenna system. Typically, this side would be a device which has control over the antennas, e.g. a base station, a terminal, or PC, in the communication system. In the following a terminal will be used as an example, but it should be understood that the same implies to any device whit a plurality of antennas. The terminal controls N elements and the number of possible antenna sub-system is

$${N}_{s} = ( \begin{matrix}N \\ {N}_{d}\end{matrix} ) \qquad ( 4 )$$

This number can still become cumbersome from a computational point of view. However, a smaller antenna system does not result in too many combinations.

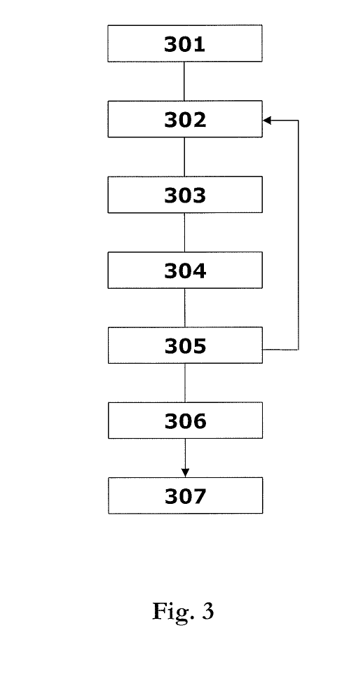

The antenna sub-systems all have in common that they only have as many antenna elements as the number of streams. Evaluating the SVD for the sub-antenna systems result in Nₐ-tuples of singular values. Here Nₐ is a number which is larger than or equal to the minimum requirement of the system, e.g. number of PA (Power Amplifiers) or data streams N_{d}. In order to select a specific antenna sub-system some metrics must be defined on these tuples. A possible singular value metric is the quotient of the arithmetic and geometric mean. Here it should be pointed out that the geometric mean is less than or equal to the arithmetic mean. The equality holds for the case that all numbers are equal. This metric can be used if the goal is to have a measure of the singular value spread. Thus, minimizing the metric will result in a system which allows similar rates on all streams. In case the metric is chosen to be only the arithmetic mean it would reflect the antenna sub-system which passes all streams easily in the channel, i.e. high gains for each stream. This metric is particularly interesting since it can be computed quickly and at a low cost, that is

$$m ( H ) = \frac{1}{{N}_{d}} tr ( {AHBB}^{T} {H}^{H} {A}^{T} ) \qquad ( 5 )$$

Where A and B are row and column selection matrices respectively and ( )^{H} is the Hermitian operator and ( )^{T} is the transpose operator. This means that there is no need to compute the singular values explicitly; the selection may be carried out under any circumstance. A metric based on the geometric mean is equivalent to the use of the determinant as metric. Common to all three described metrics are that they do not need the full SVD of the sub-channel matrix. However, when using a winning candidate the singular vectors are needed at the transmitter and receiver. Finally, it must be stressed that any metric related to the communication system can be used. An obvious candidate is an expression for the channel capacity of the given system. An exhaustive search can be defined in the following steps, with reference to FIG. 3:
301. Compute the SVD of the full channel matrix, Nᵣ×Nₜ and compute the effective rank, N_{d} of the channel via, e.g. water filling.
301′. Optionally initialize metric.
302. Choose elements from the channel matrix by deleting rows or columns such that the resulting matrix has at least dimension Nₐ×Nₐ.
303. Compute the metric for the of the obtained sub-channel matrix from the previous step.
304. Is this metric better than previous metric? If yes: save it as best and save corresponding selection.
305. Are there any combinations left? If yes: go to step 302.
306. Retrieve the best selection and form the corresponding sub-channel matrix and compute the SVD.
307. Use the obtained singular vectors at the transmit and receive side. The obtained singular vectors may be transmitted to each side of the communication link or the obtained channel matrix may be communicated between involved radio communication devices.

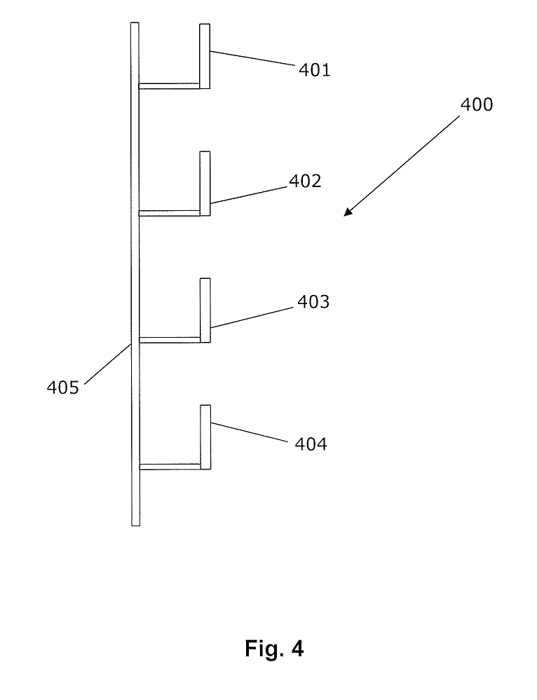

In one embodiment of the present invention the solution according to the present invention is used for a uniform linear array (ULA) antenna configuration. A ULA may be defined as an antenna comprising a plurality of substantially identical antenna elements arranged in a single line or in a plane with uniform spacing and with a substantially uniform feed system. Such an antenna system 400 is shown in FIG. 4, with four antenna elements (401-404) arranged on a single line. All antenna elements are connected in this embodiment to a common pole 405; however, it should be understood by the skilled person that the antenna elements in a ULA may all or partly be located on other poles or other positioning arrangements as long as they are positioned in a linear array configuration relative to each other.

The optimal antenna, e.g. a ULA, for MIMO communication is described by singular vectors, derived from the channel matrix or its covariance matrix. Suppose the channel can support two data streams, with a reasonable transfer rate, then it suffices to use two elements. This implies that given the data used to compute the channel matrix any combination of K elements in the ULA results in a channel matrix. The number of possible combinations where K elements are used out of N and where those elements are separated by the one element spacing may be computed as

N−K+1 (6)

To assert the best choice all combinations must be evaluated. The number of combinations can be reduced even further by exploiting the symmetrical structure of a ULA.

An alternative to evaluating the metric for a collection of matrices and or the final SVD is to view the antenna array weights as a predictor polynomial. That is,

$$A ( {q}^{- 1} ) = 1 + {\sum }_{k} {a}_{k} {q}^{- k} \qquad ( 7 )$$

This can be motivated by simply regarding the antenna diagram as the spectrum generated by the predictor. Assuming that the N_{d} data streams are independent one can use a sub-optimal scheme instead of the optimal. This implies that the streams are pre-coded using weights which are sub-optimal, but better than random pre-coding. The scheme is based on an initial SVD computation of the channel matrix. Next the effective channel rank is computed which means that N_{d} streams can be transmitted. Optimally, all antenna elements should be weighted by the singular vectors corresponding to the N_{d} largest singular values. This implies that all, N, elements of the full ULA are used which may be undesirably. By considering the vectors as predictor polynomials it is possible to reduce the ULA to dimension N_{d}, using the step down conversion outlined below. Hence, by considering the singular vectors as a predictor polynomial a very efficient way of computing vectors of lower order is provided. A lower order here signifies that the number of coefficients is reduced. Dimension wise this correspond to reducing the channel matrix to a sub-matrix. Moreover, the spectrum generated by the lower order predictor is similar to the original spectrum. The method which converts an N:th order predictor to an N_{d}:th order predictor is known as the step down conversion. In pseudo code this is
1. Let A_{N} be an singular vector of interest
2. Normalize A by its first element.
3. for k=N down to N_{d}
4. for I=0 to k−1
5.

$${a}_{k - 1} ( l ) = \frac{{a}_{k} ( l ) - {a}_{k} ( k ) {a}_{k}^{*} ( k - 1 )}{1 - {\vert {a}_{k} ( k ) \vert}^{2}}$$

6. end for I
7. end for k

Here aₘ(n) denotes the n:th coefficient of the m:th order predictor. Basically, for each outer loop the polynomial is reduced by one coefficient. Since the polynomial was initiated as the singular vector the lower order approximations have similar directivity. However, using this pseudo code approach on the N_{d} singular vectors produces a new set of N_{d} vectors of dimension N_{d}. Unfortunately these are not necessary orthogonal, implying that the weights are suboptimal pre-coders in the original context. An example of the ideas in the present disclosure will be provided.

Suppose we have an antenna installation having four antenna elements (see for instance FIG. 4) at the base station but all antenna elements 401-404 will not be used in the transmission. The reason may be that the base station will try to use one element for other purposes or that it can only provide three simultaneously active radios. Hence, the system will be reduced from four to three antenna elements. Moreover, it is assumed that only the terminal can alter the number of antenna elements. Then according to Eq. (4), there exist four combinations. The antenna subsystem selection is based on Eq. (5).

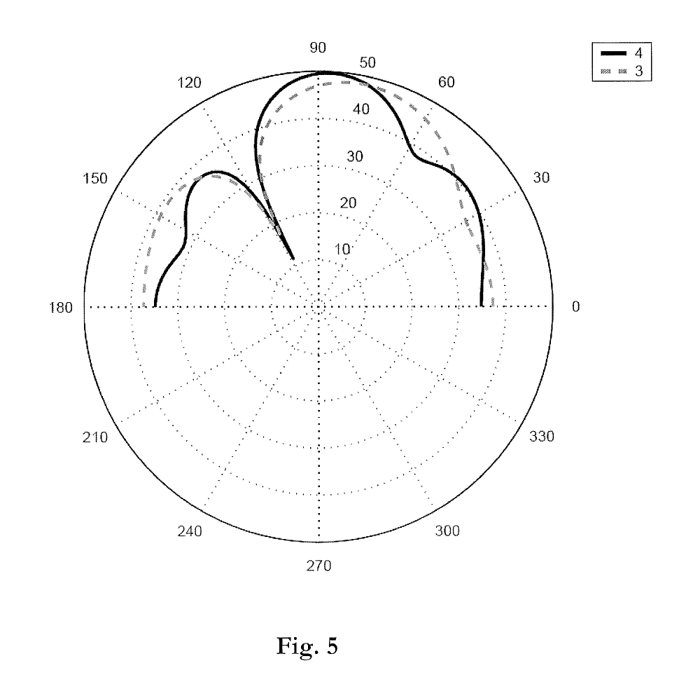

In FIGS. 5-7, the solid curve represents antenna diagrams generated from the three singular vectors corresponding to the three largest singular values of H. However, these need to be changed in order to free one antenna element. The dashed curve is obtained by reducing the singular vector polynomial using the step down procedure shown in pseudo code above. It can be noted that the reduced polynomial result in diagrams (dashed curves) which are reasonable approximations of the optimal diagrams (solid curves).

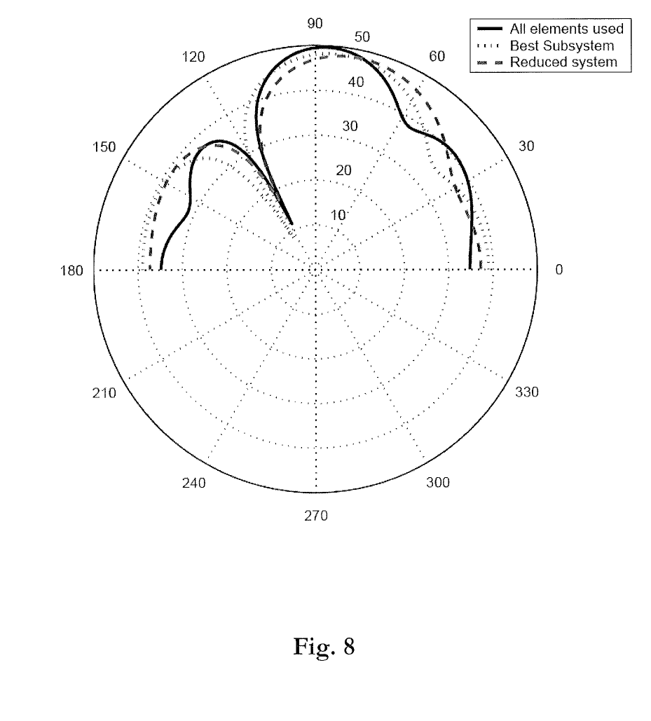

In FIGS. 8-10, a comparison of the four element antenna (solid curve), the optimal diagram for the sub channel having the best metrics (dotted curve) and the diagram derived from a reduction of the four elements antenna weights (dashed curve). It is seen that all diagram generate reasonable patterns.

FIG. 5:

The solid curve corresponds to the beam generated via the first singular vector the dashed curve is the beam generated via predictor reduction. The antenna solution generating the solid curve requires four elements whereas the dashed needs three.

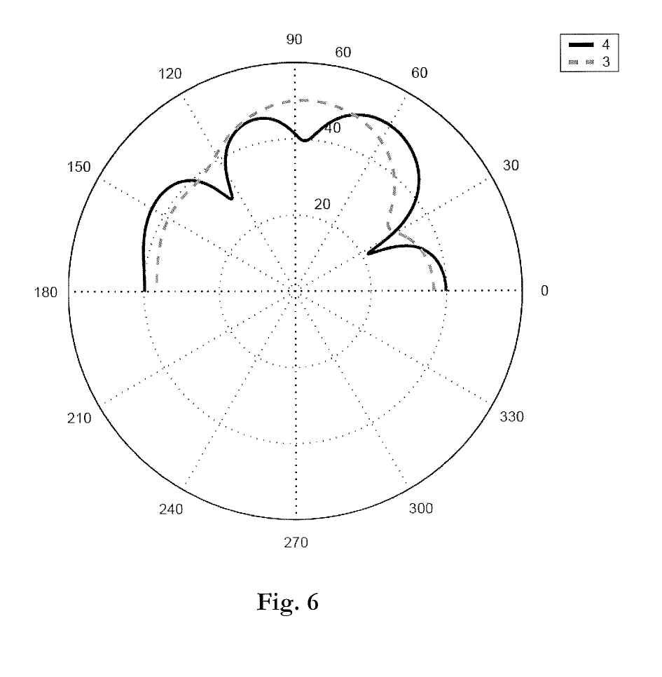

FIG. 6:

The solid curve corresponds to the beam generated via the second singular vector the dashed curve is the beam generated via predictor reduction. The antenna solution generating the solid curve requires four elements whereas the dashed needs three.

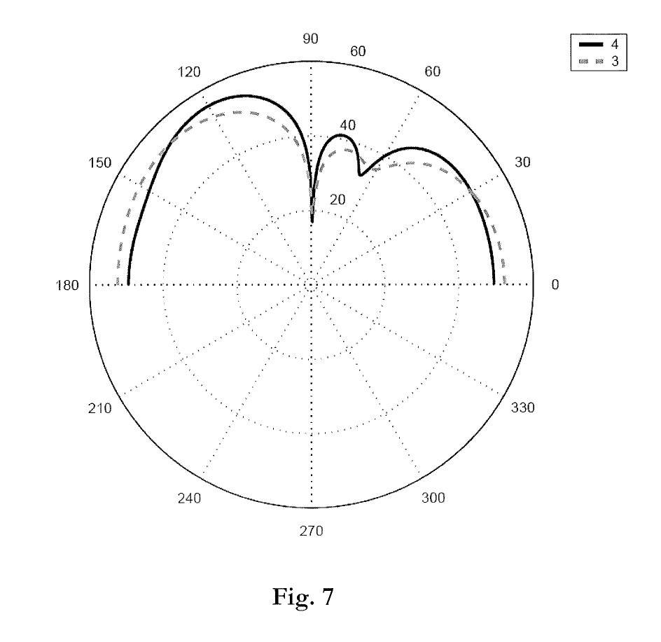

FIG. 7:

The solid curve corresponds to the beam generated via the third singular vector the dashed curve is the beam generated via predictor reduction. The antenna solution generating the solid curve requires four elements whereas the dashed needs three.

FIG. 8:

The solid curve corresponds to the beam generated via the first singular vector using all antenna elements. The dotted curve is the beam generated by the first singular vector of the best sub channel matrix. The dashed curve is the diagram obtained from a reduction of the polynomial generating the solid curve.

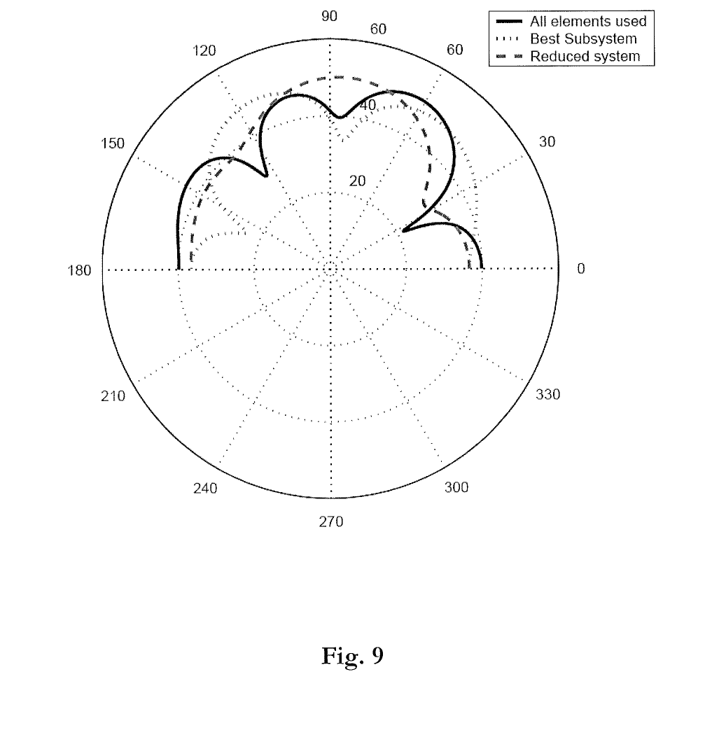

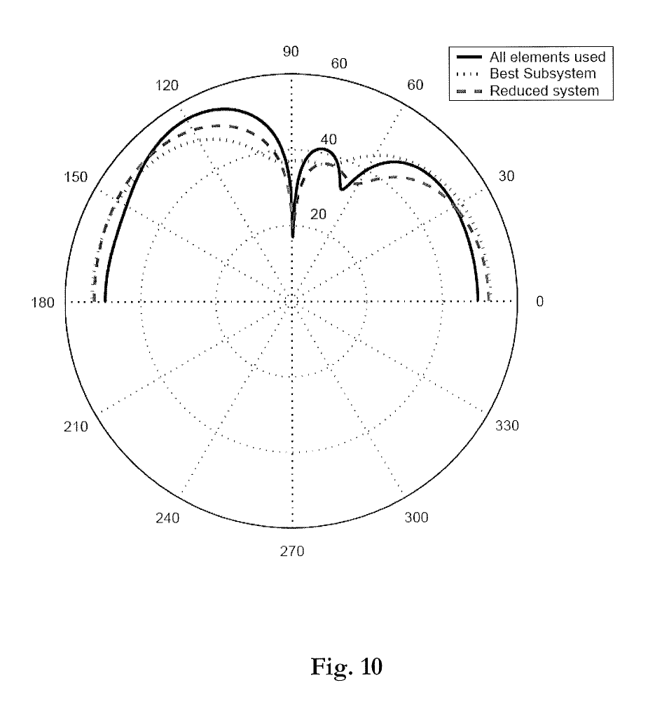

FIG. 9:

The solid curve corresponds to the beam generated via the second singular vector using all antenna elements. The dotted curve is the beam generated by the second singular vector of the best sub channel matrix. The dashed curve is the diagram obtained from a reduction of the polynomial generating the solid curve.

FIG. 10:

The solid curve corresponds to the beam generated via the third singular vector using all antenna elements. The dotted curve is the beam generated by the third singular vector of the best sub channel matrix. The dashed curve is the diagram obtained from a reduction of the polynomial generating the solid curve.

In addition it is important to stress that the polynomial must not have roots on the unit circle. In case it has, the recursion fails. Fortunately, this may be repaired by pulling the roots off the unit circle, for example by

ãₖ(l)=aₖ(l)C^{l} l=0 . . . N−1 (8)

Note that the constant C is either less or greater than one.

Choosing an array with fewer elements is of course of interest since, for example, the power consumption can be reduced. A shared PA can deliver more power, to a lesser number of elements.

It should be noted that even though the present invention has been exemplified using a base station or terminal other MIMO equipped devices may be implemented with the solution according to the present invention, e.g. a mobile phone, a laptop, a router, an access point, a gateway, and so on assuming they have a wireless communication interface of suitable type operating with a plurality of antennas (e.g. WLAN (wireless local area network), WPAN (wireless personal area network), Cellular networks (such as GSM, GPRS, WCDMA, and so on), and so on). Standards where the present solution may find applicability is for instance IEEE 802.11, 802.15 and 802.16 series of protocols, 3GPP based protocols, and so on. It should be noted that the devices implementing the present invention may utilize the concept on several radio protocol solutions, for instance a terminal device may be equipped with several radio communication interfaces each operating on a specific radio protocol, e.g. WLAN and cellular interface.

The method according to present invention may be implemented as software implemented for a processing unit as discussed earlier in relation to FIG. 2 and implemented together with other control and user software of the device. The software may be arranged to be distributable to be installed or easily updated in devices using the present invention. The software may be distributed using any suitable distribution solution depending on the type of device into where the software is configured for; for instance distributed over a communication network or on a storage medium (e.g. CD-ROM; DVD, USB memory, Flash memory, and so on as understood by the skilled person). For instance for installing the software on a mobile phone, the software may be installed during manufacturing of the phone, distributed using the communication interface with a base station or like, or distributed to a personal computer (PC) to which the mobile phone may connect to and the software may be distributed using any suitable communication interface to the phone from the PC. The software may also be distributed at a later stage and sold or otherwise being provided as a computer program product.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A communication node for controlling wireless communication in a communication network, the node comprising a transceiver portion, a processing unit, a memory unit, and a network communication interface, the transceiver portion is arranged to control a plurality of antennas, characterized in that the processing unit is arranged to determine the number and identity of antennas to use in a communication session with another communication node and wherein the processing unit is arranged to determine at least one metric from a number of singular values obtained from a singular value decomposition, i.e. SVD, of at least one sub-set of available channel matrices obtained from a SVD of a full channel matrix for the transmission and choosing an antenna configuration for which the metric is within a predetermined range

2. The communication node according to claim 1, wherein the metric from the number of singular values obtained from the SVD of the sub-set of available channel matrices are chosen from at least one of arithmetic mean, geometric mean, a predictor polynomial filter algorithm, or channel capacity.

3. The communication node according to claim 1, further arranged to determine the channel matrix using the sub-set and to transmit the determined channel matrix to at least one other node in the communication network.

4. The communication node according to claim 1, wherein the processing unit is arranged to periodically change antennas used for transmitting control messages.

5. The communication node according to claim 1, wherein the processing unit is arranged to determine signal quality for the antenna configuration available in order to determine the channel matrix using pilot signals in control messages

6. The communication node according to claim 1, further arranged to select which node that is to control the number of antennas to use in transmission of data.

7. The communication node according to claim 1, wherein the communication interface comprise at least one of wireless local area network, a wireless personal local area network, and a cellular network.

8. The communication node according to claim 1, wherein the device is further arranged to operate as one of a base station or a terminal device.

9. A method for optimizing a communication link using a plurality of antennas, comprising the steps of:
Computing a singular valued decomposition, i.e. SVD, of a full channel matrix of an antenna system between two nodes in a wireless communication network;
Initializing a quality metric;
Choosing elements from the channel matrix and obt81i1ing a sub-channel matrix;
Computing and storing the quality metric for the obtained sub-channel matrix:
Comparing the computed quality metric with previously computed quality metrics for other sub-channel matrices;
Choosing a suitably valued metric from the comparison;
Selecting the corresponding sub-channel matrix and computing the SVD using this sub-channel matrix;
Using obtained sub-channel matrix configuration for transmitting and receiving communication data.

10. The method, according to claim 9, wherein the step of computing the metric comprise at least one of using geometric and/or arithmetic mean, a predictor polynomial, or a channel capacity.

11. The method according to claim 9, further comprising a step of determining the channel matrix using the obtained sub-channel matrix configuration and communicating the channel matrix to involved radio devices.

12. The method according to claim 9, further comprising a step of periodically change antennas used for transmitting control messages.

13. A system for wireless communication in a communication network, comprising
a communication node according to claim 1;
at least two antenna elements;
wherein the communication node controls transceiver signals to the at least two antenna elements using separate power amplifiers.

14. The system according to claim 13, wherein the communication node is arranged to periodically change antennas used for transmitting control messages

15-16. (canceled)
